(19) United States
(12) Patent Application Publication
(10) Pub. No.: US 2023/0259805 A1
(43) Pub. Date: Aug. 17, 2023

(54) Resistive Flex Attenuator for a Qubit Environment

(71) Applicant: Quantum Circuits, Inc., New Haven, CT (US)

(72) Inventors: Samuel H. Moseley, Jr., New Haven, CT (US); Pratheev Sabaratnam Sreetharan, Concord, MA (US); Robert John Schoelkopf, III, Madison, CT (US)

(21) Appl. No.: 17/966,340

(22) Filed: Oct. 14, 2022

Related U.S. Application Data
(60) Provisional application No. 62/255,923, filed on Nov. 16, 2015.

(51) Int. Cl. G06N 10/40; H01P 1/22

(52) U.S. Cl. CPC G06N 10/40; H01P 1/227

(57) ABSTRACT

A resistive flex microwave attenuator for coupling control signals to a quantum computational hardware system includes a set of planar transmission lines, each such planar transmission line having first and second ends along a longitudinal axis. Each such planar transmission line includes: a set of ground planes disposed in a direction parallel to the longitudinal axis; a dielectric disposed in a direction parallel to the longitudinal axis and in contact with the set of ground planes; a signal line disposed in a direction parallel to the longitudinal axis and in contact with the set of ground planes; a metallic layer disposed around the set of ground planes; an input, coupled to such planar transmission line at the first end, and configured to receive the control signals; and an output, coupled to such planar transmission line at the second end, and configured for coupling to the quantum computational hardware system. At least one member selected from the group consisting of a ground plane of the set of ground planes and the signal line is resistive to provide attenuation. The set of planar transmission lines has a geometry configured for dissipation of heat, attributable to energy provided at the input, in a manner distributed along a length of the set of planar transmission lines. The set of planar transmission lines provide attenuation, without recourse to discrete components, across a desired frequency band. If there are a plurality of planar transmission lines, the set of planar transmission lines is disposed so that their respective ground planes are approximately coincident.

### RELATED APPLICATION

The present application claims the benefit of provisional application serial number 63/255,923, filed Oct. 14, 2021, which is hereby incorporated herein by reference in its entirety.

### TECHNICAL FIELD

The present invention relates to attenuators, and more particularly to flex attenuators to couple control signals to a quantum computational hardware system.

### BACKGROUND ART

In a quantum computer based on superconducting qubits, quantum information is carried by single microwave photons. High fidelity quantum operations require the states of these photons to be long-lived (typically longer than 100 microseconds). For such quantum states to have the long lives required for high fidelity computation, there must be no interfering environmental photons that can change the state of the system. This can be achieved in principle by cooling the qubits to sufficiently low temperatures (typically about 0.02 K) in a sealed environment. However, to execute quantum operations essential for quantum computing, the quantum information must be controlled and measured. This is done using microwave signals transmitted to and from room temperature electronics.

An interface is the structure used to transport signals between room temperature electronics and cryogenic quantum hardware. The interface may also implement interconnects between discrete units of cryogenic quantum hardware. A basic and challenging engineering problem in the operation of superconducting qubits is to implement this interface without adding spurious signals or thermal photons from the surrounding warm (up to room temperature, about 300 K) environment, a feat that requires careful attenuation and spectral filtering.

### SUMMARY OF THE EMBODIMENTS

In accordance with one embodiment of the invention, a resistive flex microwave attenuator for coupling control signals to a quantum computational hardware system includes a set of planar transmission lines, each such planar transmission line having first and second ends along a longitudinal axis. Each such planar transmission line includes: a set of ground planes disposed in a direction parallel to the longitudinal axis; a dielectric disposed in a direction parallel to the longitudinal axis and in contact with the set of ground planes; a signal line disposed in a direction parallel to the longitudinal axis and in contact with the set of ground planes; a metallic layer disposed around the set of ground planes; an input, coupled to such planar transmission line at the first end, and configured to receive the control signals; and an output, coupled to such planar transmission line at the second end, and configured for coupling to the quantum computational hardware system. At least one member selected from the group consisting of a ground plane of the set of ground planes and the signal line is resistive to provide attenuation. The set of planar transmission lines has a geometry configured for dissipation of heat, attributable to energy provided at the input, in a manner distributed along a length of the set of planar transmission lines. The set of planar transmission lines provide attenuation, without recourse to discrete components, across a desired frequency band. If there are a plurality of planar transmission lines, the set of planar transmission lines is disposed so that their respective ground planes are approximately coincident.

Alternatively or in addition, the set of transmission is configured to provide a plurality of signal paths to the output. Also alternatively or in addition, each such planar transmission line includes a set of exposed copper thermal planes thermally coupled to the metallic layer and configured to conduct heat away from the metallic layer. Further alternatively or in addition, the attenuator is configured to couple a microcontroller to a qubit module.

Alternatively or in addition, the set of planar transmission lines has a thickness defined by a distance along a straight path from a first outside location on the metallic layer through the ground planes, the dielectric, and the signal line to a second outside location on the metallic layer, wherein the path is normal to the longitudinal axis and the set of ground planes. The set of planar transmission lines has a width defined in the direction transverse to the longitudinal axis and the straight path. The thickness is less than one half of the width.

Alternatively or in addition, at least one ground plane of the set of ground planes includes constantan. Also alternatively or in addition, the metallic layer includes copper. Further alternatively or in addition, the signal line is superconducting. Alternatively or in addition, the signal line includes titanium.

Also alternatively or in addition, the signal line has a geometry configured to exhibit, at a superconducting temperature, a bandgap at a desired critical frequency, so that it behaves as a filter passing signals below the critical frequency while strongly attenuating signals above the critical frequency.

### BRIEF DESCRIPTION OF THE DRAWINGS

The foregoing features of embodiments will be more readily understood by reference to the following detailed description, taken with reference to the accompanying drawings, in which:

FIG. 1 is a cross section of a distributed flex attenuator in accordance with an embodiment of the present invention;

FIG. 2 is a cross section of the distributed flex attenuator in accordance with an embodiment of the present invention;

FIG. 3 is a top view of a stripline implementation of a flex planar transmission line with four separate attenuators in accordance with an embodiment of the present invention;

FIG. 4 is a cross-section of a thin-film filter in accordance with an embodiment of the present invention;

FIG. 5 is a graph relating frequency to attenuation at different transition temperatures; and

FIG. 6 is a graph relating frequency to attenuation at different at different normal state resistances.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

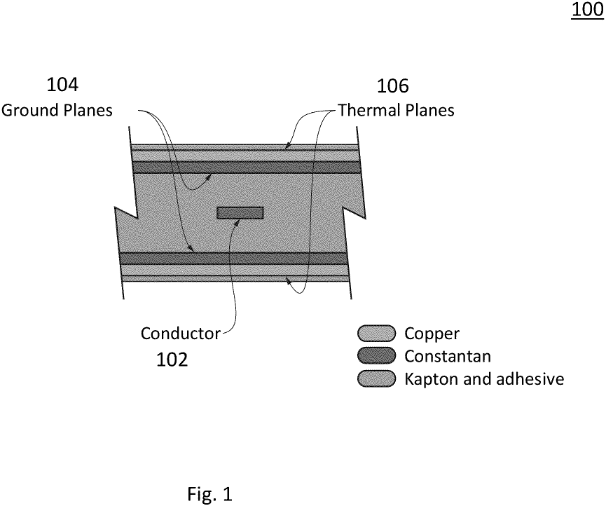

FIG. 1 shows a cross section of a distributed flex attenuator 100 in accordance with an embodiment of the present invention. Superconducting qubits are very sensitive to their photon environment. They are operated at low temperatures and shielded from stray free space radiation. Remaining sources of thermal radiation are the microwave transmission lines and components used to provide control and readout of qubits. Of particular concern are the conventional lumped attenuators, which can heat significantly with the application of drive power. Excessive heating in typical commercial attenuators results from the electron-phonon conductance in the nichrome resistive layer, so improved heat sinking of the bodies of the devices cannot provide significant improvement in performance; the limiting electron-phonon conduction can be improved only by increasing the volume of the resistive element. The design of such a large volume distributed attenuator is the subject of this application.

Here, the signal line 102 is surrounded by ground planes 104 to provide high quality shielding. Microstrip implementations, with a single ground plane 104 below the signal line 102, can be built, where we achieve greater simplicity of fabrication at the cost of lower shielding. These distributed attenuators can be made with either or both of these elements fabricated from a resistive material. The choice of which elements are resistive and which are made of high conductivity metals or superconductors allows optimization of the attenuators for different goals.

The ground planes are fabricated from high resistance material with outer surface (away from the center conductor) plated with copper. For the center conductor, two possible configurations are 1) high resistance metal or 2) high conductivity or superconducting metal. While both configurations can be designed to provide a required attenuation, the heating of these designs by applied signal is different. A resistive center conductor will rise significantly in temperature from absorbed signal power, since the dielectric does not have high thermal conductivity. It has the benefit of allowing high attenuation to be achieved in a compact volume due to the high resistance center conductor. Alternatively, using high conductivity metal or superconductor for the center achieves most of the attenuation by resistive loss in the ground planes. Since the ground plane is copper plated, it is easily cooled and the phonons in the copper stay at the local heat sink temperature even with high signal power. While the electrons in the ground planes are heated above the bath temperature, the overall temperature rise is significantly lower in this configuration. With this design, it is harder to achieve high attenuation in a compact device, but it remains much colder and provides a lower photon emission rate. The flex cable is fabricated with attachment points where the (gold plated) copper surface of the cable can be bolted or clamped to a similarly gold plated thermal sink, allowing highly efficient cooling of the cable. The wave only penetrates a small distance into the Constantan, called the skin depth. At a frequency of a few gigahertz, the skin depth is typically about 1 micrometer, much thinner than the Constantan, so the wave does not interact with the copper layer, which is there primarily to provide lateral thermal conductance.

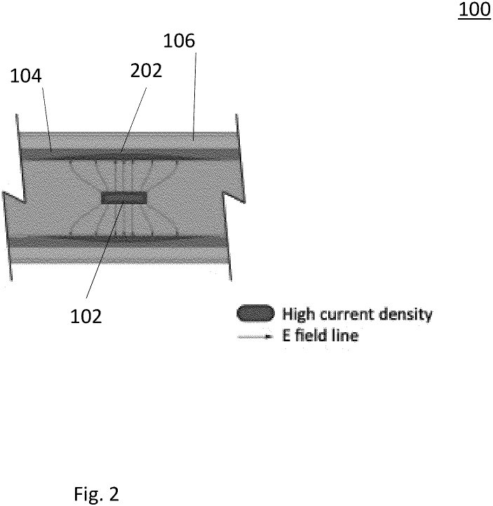

FIG. 2 shows another cross section of the distributed flex attenuator 100 in accordance with an embodiment of the present invention. As can be seen, when signals are transmitted through conductor 102 and ground planes 104 at a frequency of a few gigahertz, the skin depth 202 is smaller than the thickness of the ground plane 104. Therefore, the wave does not interact with the copper layer 106.

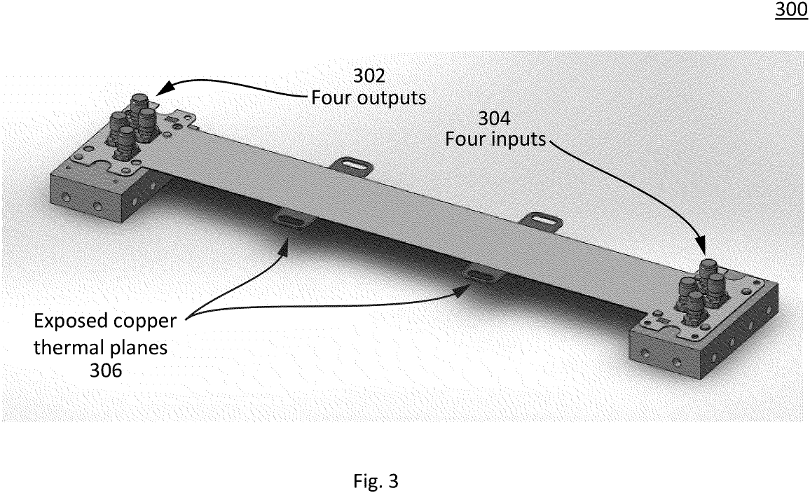

FIG. 3 shows a top view of the stripline implementation of a flex planar transmission line 300 with four separate attenuators in accordance with an embodiment of the present invention. Four distributed attenuators of the design shown in FIG. 1 connect pairs of microwave connectors 302 and 304 on opposite ends of the component. A connector 302 is electrically coupled to the signal line 102 and ground planes 104 at a first end of an attenuator 100 as used in the flex planar transmission line 300. Similarly, a connector 304 is electrically coupled to the signal line 102 and ground plane 104 at a second end of the attenuator 100. In this stripline configuration, the signal lines 102 are fully shielded by the ground planes 104. Copper tabs 306, typically gold plated, provide a high quality thermal connection to the system, limiting the temperature rise due to absorbed power. The copper tabs 306 are thermally coupled to the copper layers 106 of the attenuators. In this example, we use SMA connectors on each end 302 and 304 of each attenuator for interface to commercial microwave components. Here we see the overall geometry and the external copper heat sinking layer with attachment points 306 on the sides to make strong thermal connection to the local heat sink. While four attenuators are shown and disclosed in reference to FIG. 3, it is expressly contemplated that a lower or higher number of attenuators may be used.

Dissipative microwave components such as attenuators are heated by the internally absorbed power. At low cryogenic temperatures characteristic of superconducting qubit operation (about 0.02 K), the temperature rise resulting from even very low drive powers (<1 µW) can be significant, heating the devices to > 0.1 K, where thermal self-emission can result in significant degradation in the performance of the quantum system. Here we will describe performance of state-of-the-art commercial attenuators and show the design and performance for our attenuators being disclosed in which the thermal self-emission is reduced by factors of up to 100 over the current state of the art.

The current state of the art in operating superconducting qubits is to use commercial microwave attenuators that have been demonstrated to provide the required attenuation when operating at cryogenic temperatures. These devices have been demonstrated to provide adequate performance for many quantum information applications, especially those that can be done with low control signal power. However, even with modest drive signals, these attenuators heat and emit thermal photons which can cause decoherence in the quantum signals. Attempts have been made to improve the performance of such attenuators by increasing the thermal conductance of the attenuator substrate, moving from ceramic materials to crystalline sapphire. This change resulted in modest improvements in the self-heating of the attenuator.

The weakest thermal link in such systems is between the metallic lattice and the free electrons (e-p conductance) in the resistive attenuator material. The performance of most existing attenuators is not limited by the substrate conductance, so its improvement did not result in a large overall performance increase. Since the electron-phonon conductance does not vary strongly among materials, the best path to reduce electron heating is to increase the volume of the attenuator. For a fixed e-p conductance per unit volume, the total effective conductance increases linearly with the overall attenuator volume. Thus, in our attenuator design, we choose the volume of the device to keep the photon emission below a required level.

The design of the device has electromagnetic and thermal aspects. Electromagnetically, it is assured that the line presents a 50 Ohm impedance at its interfaces 302 and 304 to avoid reflection, and its length and resistivity determine the attenuation at a given frequency. Exemplarily, attenuators are about 30 cm long, but can be shorter or longer. The signal power and heating are largest at the input end (for example interface 302), since the power is attenuated along its length. This thermal emission from this heated input is attenuated by the remainder of the device. We can calculate the temperature profile along the length of the attenuator and sum the total emission at the output end (for example interface 304), accounting its attenuation along the device. Attenuators designed with high conductance center conductors and high resistivity ground planes have much smaller temperature rises from strong signals, and are thus favored for use with sensitive quantum elements whenever allowed by system design considerations.

The temperature at each point in the attenuator for a given power input is determined by the thermal conductance to the cryogenic heat sink. There are two dominant terms, the e-p conduction in the metal of the attenuator, and the conductance between the center conductor 102 and the conductive ground plane 104. Here, we maximize the e-p conduction by increasing the size of the attenuator, thus decreasing the power density in the resistor. The conductance between the center conductor 102 and the heat sink attached to the ground plane 104 is set by the geometry and the conductance of the insulator 106 (polyimide in our case). Phonon heating can be limited by using a high conductance center conductor with a resistive ground plane that can be efficiently cooled. Maintaining a fixed attenuation as the length is increased (with transverse dimensions fixed) requires a change in material resistivity.

In this flex attenuator, the thermal occupation number at its output can be reduced by up to a factor of 100 over the state of the art in a way that can be accurately predicted from a priori models. Thus, the system can be designed with so the effects of thermal photons are minimized while achieving required gate speeds. The stripline planar transmission line can be produced on a small scale so as to remain a single mode structure up to the highest frequencies of concern, around 300 GHz.

We have tested the performance of a transmission line attenuator, in accordance with an embodiment of the present invention, at 0.020 K. We have found that (1) the attenuation is consistent with predictions based on known properties of the materials, and (2) the heating of the attenuation due to input microwave power is much lower than in state of the art commercial attenuators and in good agreement with a priori predictions from known material properties. Below we describe these measurements and compare them with predicted performance.

The state of the art attenuators used in most superconducting qubit experiments are the XMA attenuators. They provide excellent stability in attenuation over the 0 - 10 GHz range from room temperature to the 0.020 K operating conditions. We have measured the output thermal photon occupation number of an XMA attenuator, as well as that of an attenuator in accordance with an embodiment of the present invention (hereinafter the “QCI flex attenuator”), as a function of input power. The measurement was done by overcoupling the attenuator to a cavity and measuring the occupation of the cavity with a superconducting transmon.

In Table 1 below, we compare the heating of the QCI flex attenuator to that of a commercial XMA attenuator. Even at 10-⁷ W, the XMA has a significant thermal occupation. At 10⁻⁶ W, the QCI flex attenuator has a thermal occupation number of 0.022 compared to 5.8 for the XMA, a factor of 250 lower. The QCI flex attenuator provides the cold environment required by the quantum elements.

TABLE 1

| Power (W) | Thermal Occupation Number | |
|---|---|---|
| | XMA | QCI Flex |
| 10⁻⁷ | 1.3 | |
| 10-⁶ | 5.8 | 0.022 |
| 10-⁵ | | 0.080 |

The QCI flex attenuator, primarily because of its large volume resistive absorber, remains significantly colder in the presence of drive power, maintaining about a factor of 100 lower thermal photon output occupation at 10⁻⁶ watt input power (see Table 1). The lower thermal photon output occupatopm provides a large improvement in performance of quantum systems where low thermal photon environments are required for long device coherence times, but high drive powers are required for the high speed operations that are necessary for high fidelity gates. The QCI flex attenuator makes a big step in allowing both conditions to be met simultaneously.

Embodiments of the attenuator that is the subject of this application can be optimized to provide high transmission in the microwave band of the quantum control signals but strong attenuation at higher frequencies by constructing the signal line of a small-gap superconductor. As an example the signal line can be made of titanium which has a superconducting transition of 0.39 K. It will thus have a frequency gap of 30 GHz; it is superconducting for signals for frequencies lower than the gap, but resistive above it. A thin titanium signal line can thus create high attenuation for high frequency interfering signals while transmitting the quantum control and measurement signals with essentially zero loss.

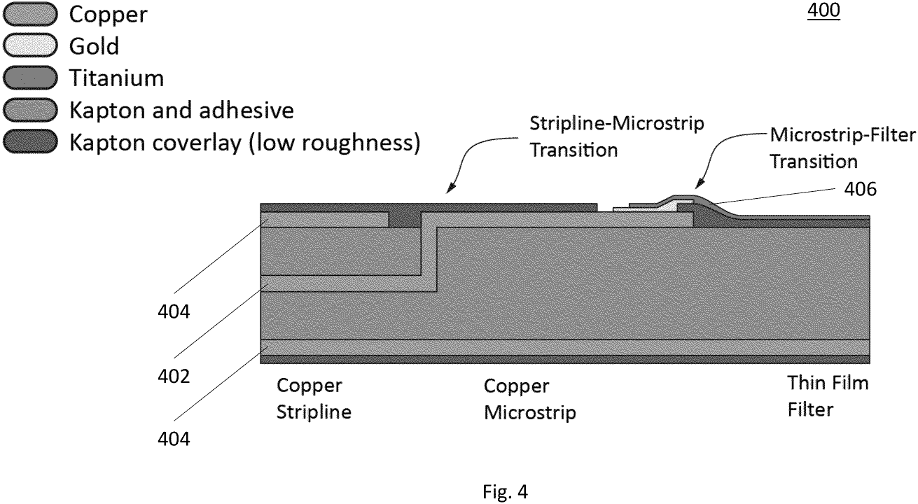

FIG. 4 shows a cross-section of a thin-film filter in accordance with an embodiment of the present invention. The thin-film filter 400 is based on the attenuator 100 described above in reference to FIGS. 1 and 2. The signal enters from the left and exits to the right. The left side of the cross section shows a stripline signal input, with a center signal line 402 and top and bottom ground planes 404. The signal transitions to a microstrip planar transmission line, with a signal line on the top and a single ground plane on the bottom. The signal line then transitions from a typical copper line to an extremely thin titanium line 406. The microstrip structure with the copper ground and the titanium signal line 406 is the thin film filter 400.

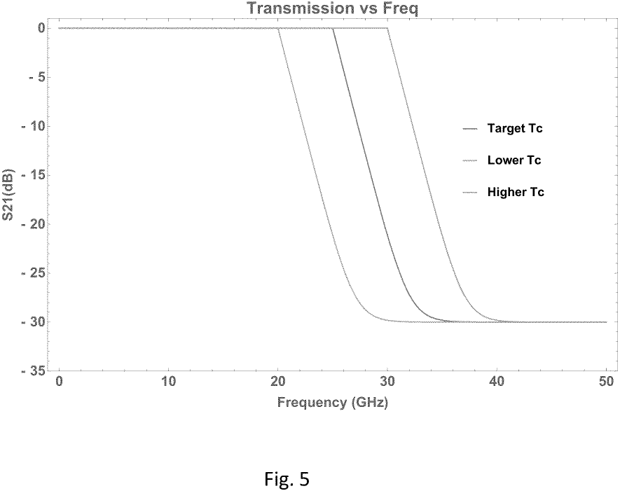

FIG. 5 shows that the transition frequency of the superconducting planar transmission line depends linearly on the transition temperature (Tc) of the superconductor. The transition frequency between lossless transmission and strong attuation is set by the energy gap of the superconductor, and is generally proportional to the superconducting transition temperature. This transition frequency can be adjusted in a range of ways. One may: 1) choose a different superconductor with a different transition. 2) tune the energy gap using bilayers or multilayers of supercondutors and normal metals. 3) use aluminum or other superconductors doped with Mn, a magnetic impurity. With these techniques, a range of transition frequencies from a few gigahertz to nearly one terahetz are achievable with available materials.

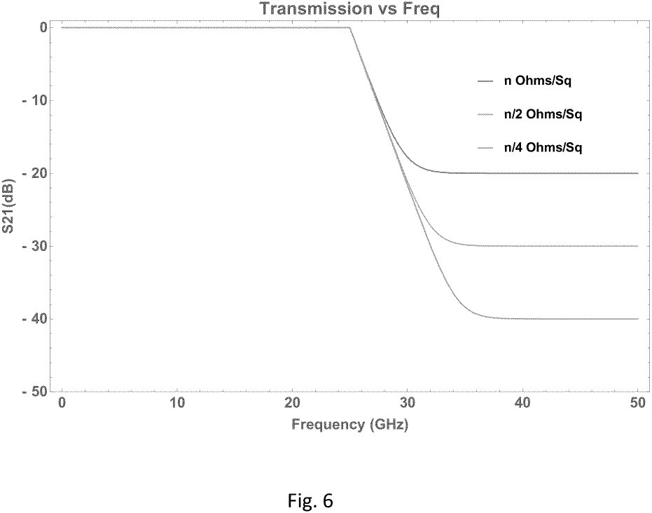

FIG. 6 shows that the attenuation in the normal state above the gap frequency of the superconductor depends on the normal state surface resistance of the superconductor. By varying the normal state resistance, the attenuation and in band performance can be optimized for specific applications.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A resistive flex microwave attenuator for coupling control signals to a quantum computational hardware system, the attenuator comprising:
a set of planar transmission lines, wherein each such planar transmission line has first and second ends along a longitudinal axis and includes:
a set of ground planes disposed in a direction parallel to the longitudinal axis;
a dielectric disposed in a direction parallel to the longitudinal axis and in contact with the set of ground planes;
a signal line disposed in a direction parallel to the longitudinal axis and in contact with the dielectric;
a metallic layer disposed around the set of ground planes;
an input, coupled to such planar transmission line at the first end, and configured to receive the control signals; and
an output, coupled to such planar transmission line at the second end, and configured for coupling to the quantum computational hardware system;
wherein (i) at least one member selected from the group consisting of a ground plane of the set of ground planes and the signal line is resistive to provide attenuation;; (ii) the set of planar transmission lines has a geometry configured for dissipation of heat, attributable to energy provided at the input, in a manner distributed along a length of the set of planar transmission lines; (iii) the set of planar transmission lines provide attenuation, without recourse to discrete components, across a desired frequency band; and (iv) if there are a plurality of planar transmission lines, the set of planar transmission lines is disposed so that their respective ground planes are approximately coincident.

2. A microwave attenuator according to claim 1, wherein the set of planar transmission lines is configured to provide a plurality of signal paths to the output.

3. A microwave attenuator according to claim 1, wherein each such planar transmission line includes a set of exposed copper thermal planes thermally coupled to the metallic layer and configured to conduct heat away from the metallic layer.

4. A microwave attenuator according to claim 1, wherein the attenuator is configured to couple a microcontroller to a qubit module.

5. A microwave attenuator according to claim 1, wherein:
a. the set of planar transmission lines has a thickness defined by a distance along a straight path from a first outside location on the metallic layer through the set of ground planes, the dielectric, and the signal line to a second outside location on the metallic layer, wherein the path is normal to the longitudinal axis and the set of ground planes;
b. the set of planar transmission lines has a width defined in the direction transverse to the longitudinal axis and the straight path; and
c. the thickness is less than one half of the width.

6. A microwave attenuator according to claim 1, wherein at least one ground plane of the set of ground planes includes constantan.

7. A microwave attenuator according to claim 1, wherein the metallic layer includes copper.

8. A microwave attenuator according to claim 1, wherein the signal line is superconducting.

9. A microwave attenuator according to claim 8, wherein the signal line includes titanium.

10. A microwave attenuator according to claim 9, wherein the signal line has a geometry configured to exhibit, at a superconducting temperature, a bandgap at a desired critical frequency, so that it behaves as a filter passing signals below the critical frequency while strongly attenuating signals above the critical frequency.
